(19) United States
(12) Patent Application Publication
(10) Pub. No.: US 2010/0039314 A1
(43) Pub. Date: Feb. 18, 2010

(54) COMMUNICATING NAVIGATION DATA FROM A GPS SYSTEM TO A TELECOMMUNICATIONS DEVICE

(75) Inventor: Shekhar Gupta, Overland Park, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/190,776

(22) Filed: Aug. 13, 2008

(51) Int. Cl. G01S 1/00

(52) U.S. Cl. 342/357.1

(57) ABSTRACT

A GPS device and method for communicating navigation data from a Global Positioning System (GPS) device to a telecommunications device includes establishing a communications link between a GPS device and a telecommunications device via a telecommunications system. The GPS device may receive GPS coordinates from the telecommunications device. The GPS device may receive a destination location selection. Directions may be calculated based on the received GPS coordinates of the telecommunications device and the selected destination location. Directions may be communicated to the telecommunications device.

### BACKGROUND OF THE INVENTION

Global Positioning System (GPS) technology has been available for military and public use for many years. Navigation devices using GPS technology display current location, speed, determine directions to a desired location, and perform many other functions. A navigation device may be handheld and portable, part of a more elaborate system that is built into a vehicle, or a variation somewhere in-between.

GPS technology has also become more frequently available in telecommunications devices, such as cellular phones. In telecommunications use, GPS technology has been mainly used to provide coordinate location information to emergency responders, such as when dialing 911. By providing coordinate locations when communicating with 911, in the event a caller is unable to speak or does not know where he or she is located, the emergency responders are able to determine the exact location of the caller, with great accuracy.

Until recently, there have not been many uses developed for GPS functionality on telecommunications devices outside of the emergency responder (911) context. More recent applications, however, are able to use GPS coordinates from a telecommunications device to display to a user of the telecommunications device a map showing the user's approximate location. Additionally, some cellular service providers also have the ability to receive a fixed destination location from a subscriber, and using the GPS coordinates of the telecommunications device, provide “turn-by-turn” directions to the subscriber via the telecommunications device. To date, the use of GPS functionality on telecommunications devices has been limited to providing current location information and directions to static addresses.

### SUMMARY OF THE INVENTION

In order to provide expanded functionality to a telecommunications device having GPS enablement, directions and related information may be communicated from a GPS device to the telecommunications device based on a selected destination and current location coordinates received by the GPS device from the telecommunications device. Directions being communicated to the telecommunications device may be updated and revised at regular intervals to take into account a scenario where the selected destination for the directions is a moving target, such as another vehicle that contains the GPS device. Continually revising directions based on changes in the destination coordinates allows for destinations that are not static and provides greater capability than what has previously been available to users of GPS enabled telecommunications devices.

One embodiment of a method for communicating navigation data from a Global Positioning System (GPS) device to a telecommunications device includes establishing a communications link between a GPS device and a telecommunications device via a telecommunications system. The GPS device may receive GPS coordinates from the telecommunications device. The GPS device may receive a destination location selection. Directions may be calculated based on the received GPS coordinates of the telecommunications device and the selected destination location. Directions may be communicated to the telecommunications device.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of an exemplary environment for communicating directions and coordinate data between a GPS device and a telecommunications device;

FIG. 2 is an illustration of an exemplary screen shot depicting a menu used to initiate peer-to-peer navigation on a GPS electronic display;

FIG. 3 is an illustration of an exemplary screen shot depicting a menu for selecting a destination and for whom the directions should be determined;

FIG. 4 is a block diagram of exemplary components of a GPS device configured to facilitate communication of directions and coordinate data with a telecommunications device;

FIG. 5 is a block diagram of exemplary software modules for a GPS device according to principles of the present invention;

FIG. 6 is an illustration of an exemplary environment for communicating directions and coordinate data between a first peer including a telecommunications device and a second peer including a GPS device in communication with a second telecommunications device;

FIG. 7 is a detailed illustration of peer-to-peer navigation depicting components of the peers in greater detail;

FIG. 8 is a timing diagram of an illustrative map to demonstrate the principles of the present invention at various points in time as two peers communicating directions and/or GPS coordinates while both are in motion; and

FIG. 9 is a flow chart of an exemplary process for communicating directions and coordinate data between a GPS device and a telecommunications device.

### DETAILED DESCRIPTION OF THE DRAWINGS

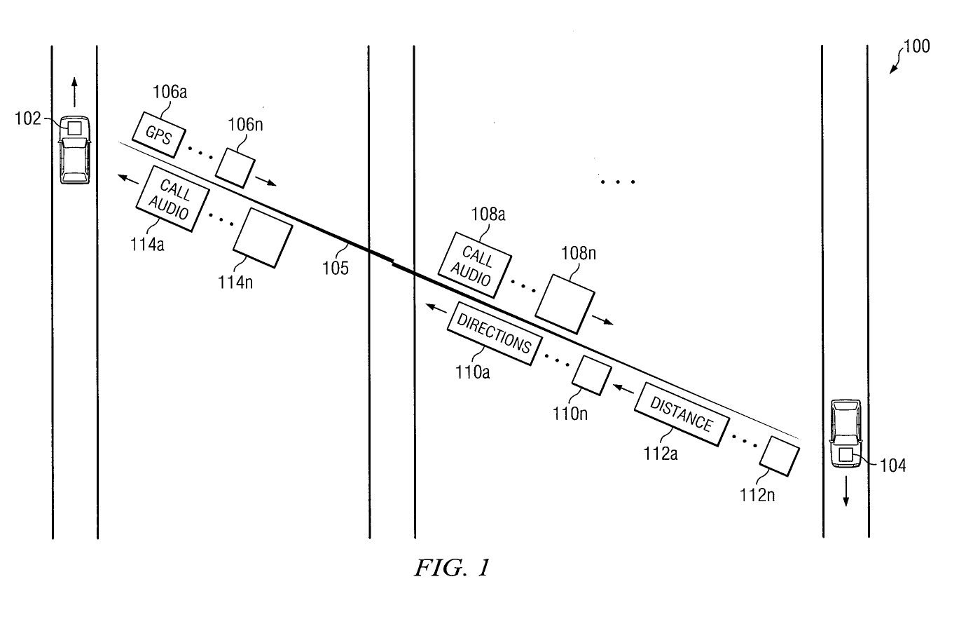

FIG. 1 is an illustration of an exemplary environment 100 for communicating directions and coordinate data between a GPS device and a telecommunications device. In one embodiment, a telecommunications device 102, such as a GPS enabled phone, may be in communication with a GPS device 104 via a wireless network 105, such as a cellular network. Other examples of the wireless network 105 may be Wi-Fi or WiMax type networks. GPS coordinates 106a-106n (collectively 106), call audio data 108a-108n (collectively 108), as well as other data (not shown) may be communicated from the telecommunications device 102 to the GPS device 104 via the wireless network 105. Concurrently, directions 110a-110n (collectively 110), distance data 112a-112n (collectively 112), outgoing call audio data 114a-114n (collectively 114), as well as other data (not shown) may be communicated from the GPS device 104 to the telecommunications device 102 via the wireless network 105.

The telecommunications device 102 may be a cellular telephone, personal digital assistant (PDA) device, pager, or any other type of telecommunications device capable of determining and communicating GPS coordinates 106 related to the telecommunications device's 102 current location. The GPS device 104 may be a hand-held portable navigation device, a built-in navigation device, such as a vehicle navigation system, or any other mobile device capable of determining location positions, and generating directions. The GPS device 104 may be configured to communicate with the telecommunication device 102.

The GPS device 104 may include a built-in transceiver or other components configured to communicate with the wireless network 105. If the GPS device 104 does not include components that allow for communicating via the wireless network 105 with the telecommunications device 102, (such as a built-in cellular transceiver or wireless network interface), the GPS device 104 may have components that allow a local telecommunications device (not shown) to communicate over Bluetooth™ or some other local connection, such as a physical link, with the GPS device 104. Using the local telecommunications device, the ability to communicate with the telecommunications device 102 via the wireless network 105 may then be enabled.

The GPS coordinates 106 communicated by the telecommunications device 102 may be standard coordinates (e.g. latitude 32.9324, longitude −80.0474), as are commonly known in the art related to the Global Navigation Satellite System (GNSS). The GPS coordinates 106 may be communicated separately or along with other call audio data 108 (e.g., voice data) via the wireless network 105, such as a cellular network. In addition to latitude and longitude, altitude and time are well known to be transmitted by satellites used in the GNSS. However, altitude and time may not be necessary to carry out the principles of the present invention. In one embodiment in addition to the current location for the GPS device 104 being displayed within a map on the GPS device 104, a current location for the telecommunications device 102 may also be displayed by the GPS device, based on the GPS coordinates 106 that were received from the telecommunications device 102. Having the locations depicted of both of the devices 102 and 104 allows the user of the GPS to have a visual display of their locations relative to each other.

Using the GPS coordinate data 106 received from the telecommunications device 102, the GPS device 104 may be used to determine directions to transmit to the telecommunications device 102. A destination selection is made in order for directions to be calculated. The destination selection process is described in detail below in FIG. 3. Destination coordinates, including coordinates that may change over time (e.g. the location of a moving vehicle or target), may be provided by a user of the GPS device, the GPS device itself, the user of the telecommunications device 102, or the telecommunications device 102 itself. The GPS device 104 may use the destination coordinates together with the GPS coordinates 106 to develop directions 110 for communications to the GPS telecommunications device 102. As described previously, along with the directions 110, distance data 112 may also be communicated via the wireless network 105. The distance data 112 may be based on calculations which determine the distance between the GPS enabled phone and the destination coordinates. In addition, estimated time of arrival (ETA) may be calculated based on distance and speed limits or actual speeds of either or both vehicles 116a and 116b in which the telecommunications device 102 and GPS device 104 are respectively located. Such calculations are readily understood by one skilled in the art of GPS devices.

In addition, the directions 110 to the destination coordinates may be constantly updated to take into account the situation where the destination coordinates are linked to a moving target. In other words, if a user of the telecommunications device 102 is seeking to locate the position of the GPS device 104 in the moving vehicle 116b, the directions to locate the GPS device 104 in the moving vehicle are likely to change over time. A more detailed description of different scenarios involving static or moving destinations are described below in FIGS. 3, 5, and 8.

As with the call audio data 108 received from the telecommunications device 102, outgoing call audio data 114 may also be sent from the GPS device 104. Outgoing call audio data 114 may be sent in the case where the GPS device 104 includes a transceiver (not shown) capable of communicating a call or from an attached or locally linked telecommunications device (not shown) in communication with the GPS device 104 as described previously.

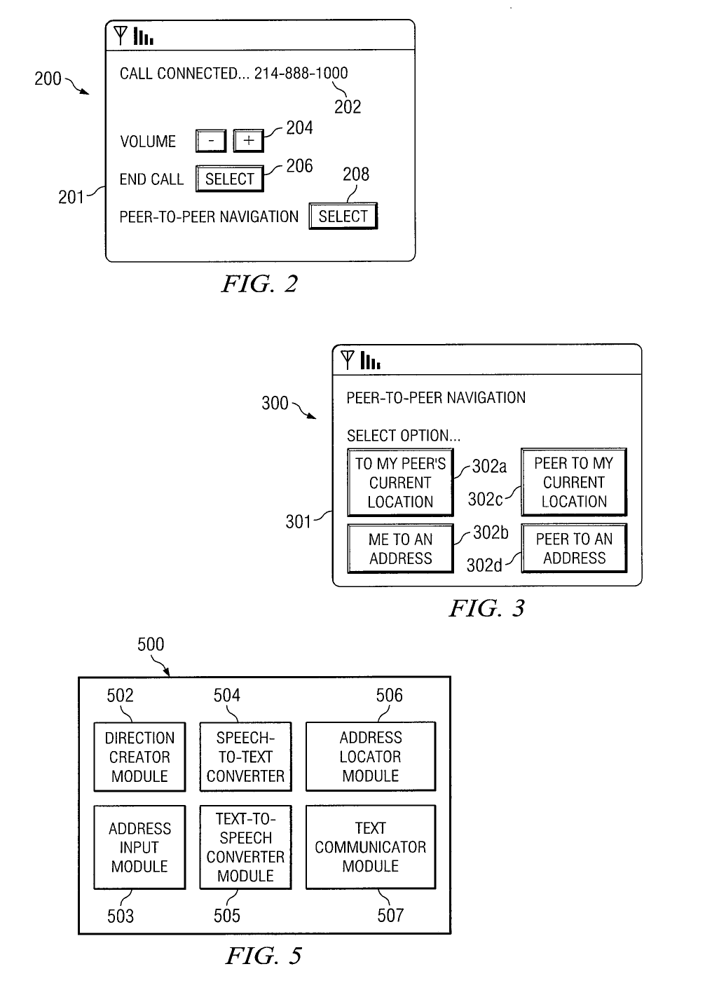

FIG. 2 is an illustration of an exemplary screen shot 200 depicting a peer-to-peer navigation select button 208 used to initiate peer-to-peer navigation on a GPS electronic display 201. The GPS electronic display 201 may be a touch screen that allows a user to input selections by simply pressing on the display 201. Alternatively, the GPS electronic display 201 may be a traditional monitor using other forms of input, such as hard-keys adjacent to the electronic display 201, commonly known in the art. The screen shot 200 displays typical information that may be shown on the GPS electronic display 201 while a call is in progress. A telephone number 202 of a connected telecommunications device (not shown) may be displayed. Alternatively, or in addition, a user's name (not shown) associated with the telephone number 202 may also be displayed. Volume control buttons 204 may also be presented on the GPS electronic display 201 to allow a user to control the level of incoming call volume. An end call select button 206 may also be presented for allowing a user to disconnect a call during transmission. If a call is ended while directions or coordinates are being communicated, the principles of the present invention allowing for peer to peer navigation may not be fully successful. In other words, a communications link between two peers may be necessary for the entire time during transmission of directions and other data. The peer-to-peer navigation select button 208 may be selected to initiate another menu screen, such as screen shot 300 of FIG. 3. During a call or other connection between peers (e.g., a GPS device and a telecommunications device), a user of the GPS electronic display 201 is provided with the option to initiate peer-to-peer navigation functionality by selecting the peer-to-peer navigation select button 208. If a traditional phone call is desired with no need to initiate the communication of directions, a user simply refrains from pressing the peer-to-peer navigation select button 208.

FIG. 3 is an illustration of an exemplary screen shot 300 depicting a menu for selecting a destination and a recipient for determined directions on a GPS electronic display 301 of a GPS device. Menu selection buttons 302a-302b (collectively 302) may be displayed to a user of the GPS electronic display 301. A user may select one of the selection buttons 302a-302d to indicate what type of directions are to be determined and if the directions are intended for the peer (e.g., a person with whom the user is speaking to on the GPS device) or for displaying on the GPS electronic display 301. Additionally, a user may select more than one the menu selection buttons 302 to provide for multiple directions to be determined concurrently. For example, a user of the GPS electronic display 301 may want to determine directions to their peer, while concurrently sending directions to their peer to find the user.

By selecting the selection button 302a stating “TO MY PEER'S CURRENT LOCATION,” the directions for locating the peer (i.e., the person operating the telecommunications device communicating with the GPS device) is calculated using received GPS coordinates from the telecommunications device. For selection button 302a, the directions may be presented to the user of the GPS device. As a user of the GPS electronic display 301 advances to the destination, as long as there is a communication link between the telecommunications device and the GPS device, the displayed directions may be continually updated to take into account that the current location of the peer may not be static.

By selecting the selection button 302b stating “ME TO AN ADDRESS,” the GPS electronic display 301 functions as a traditional GPS device giving directions intended only for display on the GPS electronic display 301 to a static address location. A connection to a telecommunications device may not be necessary for the functionalities of the selection button 302b to occur. Rather, the availability of the GPS device coordinates and the coordinates of a fixed address would be the only necessary coordinates.

If the user of the GPS electronic display 301 selects the selection button 302c “PEER TO MY CURRENT LOCATION,” directions may be calculated based on GPS coordinates received from the telecommunications device and the GPS coordinates generated by the GPS device. The calculated directions may then be communicated to the telecommunications device. The communicated directions may be in audio format, in text format (e.g., an SMS message or email), or in any other format that the telecommunications device is configured to receive. Similar to choosing selection button 302a, as the user of the telecommunications device that is receiving the directions advances to the destination, directions may be updated to take into account that the destination location may not be static, but moving as well. In one embodiment, in addition to communicating directions to the peer, directions may also be presented to the user, such as shown in FIG. 8.

Another option may be the select button 302d for “PEER TO AN ADDRESS” directions. If a peer, using a telecommunications device in communication with the GPS device or a GPS device enabled to access a network, would like directions to a static address, the option to send the peer directions is provided by the select button 302d. After selecting the select button 302d, an address may be input into the GPS device. Using the GPS coordinates of the input address and the GPS coordinates received based on the telecommunications device location, directions may be calculated and communicated to the telecommunications device. The directions may be communicated in audio, text or in any other format that the telecommunications device is configured to receive.

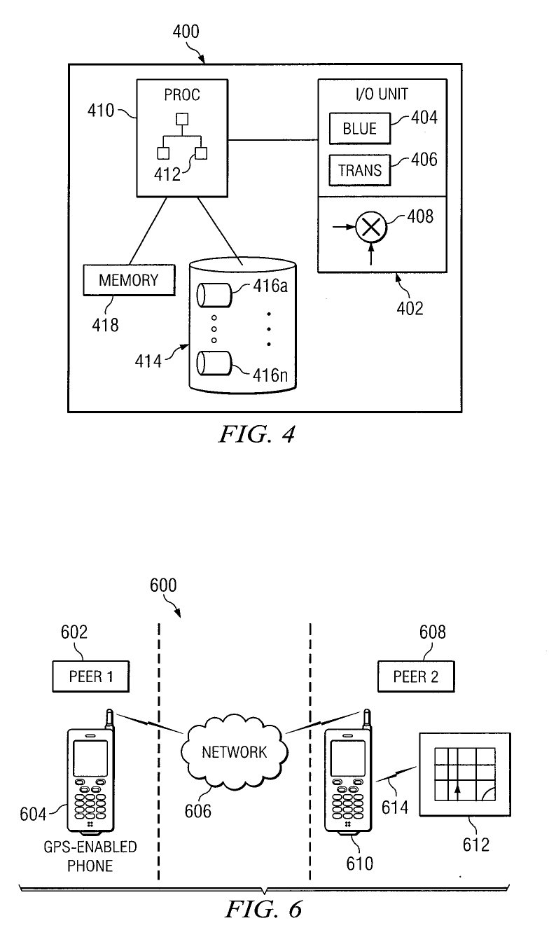

FIG. 4 is a block diagram of exemplary components of a GPS device 400 configured to facilitate communication of directions and coordinate data with a telecommunications device. The GPS device 400 may include an input/output (I/O) unit 402 for receiving audio and message data from a telecommunications device. The I/O unit 402 may additionally include a Bluetooth™ component 404 for enabling communication between the GPS device 400 and a local telecommunications device (not shown), and a transceiver 406 for transmitting and receiving GPS coordinates, voice, and other information with a remote telecommunications device (not shown). A mixer 408 may also be provided to combine audio signals from the various components. For example, voice coming into the GPS device from a user, via a microphone, and directions being communicated by the GPS device 400 via a voice synthesizer (not shown) are two examples of signals that may be combined during the operation of the GPS device 400 while the GPS device 400 is communicating directions to a peer. Similarly, data being directed to the Bluetooth™ component 404 and the transceiver 406 may also be directed by the mixer 408.

The GPS device 400 may also include a processor 410 for processing GPS navigation information, directions, and message content to and from the telecommunications device of a peer. The processor 410 may include one or more processors and may be configured to execute multiple instances of the same or different software modules in parallel to compute directions for one or more users. The processor 410 may execute software 412 capable of performing the functionality of the GPS device 400 as provided by the principle of the present invention. Software modules that may operate in the software 412 are described below in more detail in reference to FIG. 5. A storage unit 414 may also be included in, or be in communication with, the GPS device 400. The storage unit 414 may be a hard drive or any other type of volatile or non-volatile memory capable of storing data. Within the storage unit 414 may be one or more data repositories 416a-416n (collectively 416), such as a database or multiple databases, capable of storing and organizing data, such as addresses or GPS coordinates. In one embodiment, rather than including the storage unit 414, the GPS device 400 may use a memory 418 that is large enough to store data for use in providing address insertion functionality as described herein. Memory 418 may also be located within the GPS device 400 for storing data being processed by the processor 410.

FIG. 5 is a block diagram of exemplary software modules 500 for execution on a GPS device according to principles of the present invention. A direction creator module 502 may be provided for determining directions between sets of coordinates, such as GPS coordinates, that are provided to the module. As described previously, the coordinates may be for a destination that is in motion (e.g., a moving vehicle), therefore the direction creation module 502 may be configured to continually revise the directions being created based on changing coordinates, speed, direction, knowledge of roadways, and so forth. Coordinates may be provided as input from the telecommunications device, from the coordinates generated by the GPS device, or by the address locator module 506 described below.

An address input module 503 may be used when an option for directions to a specific address is selected, as described in FIG. 3. The address input module 503 may be configured to accept speech input and convert to text, using speech-to-text converter module 504 described below, or may be configured to accept input by displaying a keyboard or some other method for entering an address, as is commonly known in the art. The address input module 503 may then utilize the address locator module 506, described below, to determine the associated GPS coordinates of the entered address.

A speech-to-text converter 504 may be used for providing input into the GPS device. For example, if a user of the GPS device is inputting commands or other data using voice, the speech-to-text converter 504 may convert the words into text input that is understood by the GPS device. Conversely, a text-to-speech converter module 505 may also be provided to allow for the text generated instructions or directions to be converted to audio for communication to a user. If the user is located at the telecommunications device and is to receive the directions in audio format, the text-to-speech converter module 505 may be used to provide the directions in audio rather than in a text format, as it may be originally generated.

An address locator module 506 may be used to determine GPS coordinates based on an address that is input into the GPS device by a user. The address locator module 506 may access the storage unit 414 of FIG. 4 or another data repository containing address locations that are referenced to the GPS coordinates of the address location, which may then be used for calculating directions. Using the determined GPS coordinates, the direction creator module 502, as previously described, may then generate the directions.

A text communicator module 507 may be configured to communicate text of the calculated directions to a telecommunications device of a peer. The text communicator module 507 may communicate the text in SMS text message format, instant messaging format or otherwise. Further, the text communicator module 507 may be configured to send text messages of the directions in the event that a call communication link becomes disconnected during navigation.

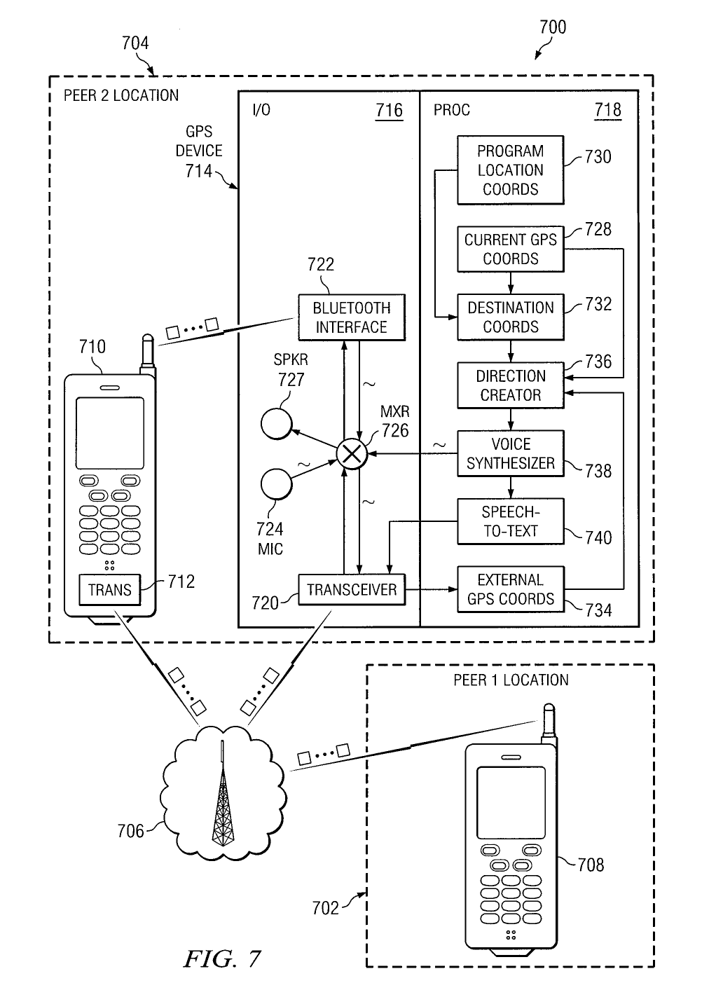

FIG. 6 is an illustration of an exemplary environment 600 for communicating directions and GPS coordinate data between a first peer 602 including a telecommunications device 604 and a second peer 608 including a GPS device 612 in communications with a second telecommunications device 610. FIG. 6 is used to provide a better understanding of the concept of peer-to-peer navigation according to principles of the present invention. Further details of events occurring for each peer is described in greater detail in FIG. 7. The telecommunications device 604, such as a GPS enabled phone, may communicate over a network 606. The network 606 may be a cellular network, the Internet, or any other network configured to communicate voice data and GPS coordinate data to the second telecommunications device 610. The second communications device 610 may be in communication with the network 606 and in communication with the GPS device 612 via local communications link 614. The local communications link 614 may be wireless, such as Bluetooth™, wired, or any other communications link 614 configured to communicate data between the second telecommunications device 610 and the GPS device 612.

FIG. 7 is a detailed illustration of an illustrative network environment 700 that provides for peer-to-peer navigation. Peer 1 location 702 and peer 2 location 704 may communicate over a network 706. In one embodiment, the network 706 may be a cellular network, the Internet, or any other network configured to communicate between the peer locations 702 and 704, as described previously. Peer 1 location 702 may contain a telecommunications device 708, such as a GPS enabled mobile phone. The telecommunications device 708 may be in communication with a peer 2 telecommunications device 710, which may include a transceiver 712, via the network 706. The telecommunications device 708, via the network 706, may alternatively communicate with the GPS device 714 via a built-in transceiver 720 without the use of the peer 2 telecommunications device 710.

The GPS device 714 may include several components, with some of the components being I/O related components 716 and other components including processor related components 718. In addition to the transceiver 720 for sending and receiving data and voice communications from the network 706, the I/O related components 716 may include a Bluetooth™ interface 722. The Bluetooth™ interface 722 may communicate data and voice communications with the peer 2 telecommunications device 710. In the event that the GPS device 714 does not contain a transceiver 720, the peer 2 telecommunications device 710, in conjunction with the Bluetooth™ interface 722, may allow the GPS device 714 to perform similar functionalities as the transceiver 720. A microphone 724 may be provided to allow a user of the GPS device 714 to deliver audio commands or other speech input to the GPS device 714. A mixer 726, formed of one or more audio mixing devices, may also be provided for combining data signals, such as audio signals, from the various components of the GPS device 714. The mixer 726 may enable two audio signals to be communicated from the GPS device 714 to the telecommunications device 708, such as voice data from a user of the telecommunications device 708 and audio directions generated by the GPS device 714, as described further herein. A speaker 727 may also be provided to allow audio generated by the GPS device 714, or communicated to the GPS device 714, to be heard by a user of the GPS device 714.

Within the processor 718 may be a current GPS coordinates generating component 728. The current GPS coordinates generating component 728 may determine current GPS coordinates of the GPS device 714 and may communicate the generated GPS coordinates to a destination coordinates component 732 or a direction creator component 736 for processing. Another input into the destination coordinates component 732 may be the program location coordinates component 730. Certain locations may be stored in memory referenced with the location's associated GPS coordinates. In the event an address is used for a destination, coordinates may be provided by the program location coordinates module 730 for directions calculation. The destination coordinates component 732 may select the GPS coordinates depending upon the destination desired. For example, certain coordinates may be necessary for the directions, while others are not. Current GPS coordinates of the GPS device 714 may be necessary for most direction calculations except for the situation where the telecommunications device 708 requests directions to an address unrelated to the GPS device 714.

Other inputs into the direction creator component 736 may include the destination coordinates component 732, as described, as well as the external GPS coordinates component 734. The external GPS coordinates component 734 may accept input from the Bluetooth™ interface 722 as well as the mixer 726, which may receive the GPS coordinates from the telecommunications device 708 of peer 1 location 702. The external GPS coordinates component 734 may be configured to continually update the external coordinate information communicated to the direction creator component 736, thereby allowing directions to be continually or periodically recalculated when a destination is not a static location. Some examples of when recalculation may occur include periodically (e.g., 5 or 10 second intervals), continuously (e.g., as GPS updates occur), on demand (e.g., based on a user request), or event driven (e.g. peer passes a GPS marker, changes direction, veers off navigation path, etc.). The directions may then be provided to a voice synthesizer component 738 for communicating the directions in speech format. A speech-to-text component 740 may also be provided for communicating portions of the data already in audio format, such as commands or other information received in audio format from the telecommunications device 708 or GPS device via the microphone 724, into text. The components described are exemplary in nature. Additional configurations may be utilized to provide the same or analogous functionality.

FIG. 8 is a timing diagram of an illustrative map 800 to demonstrate the principles of the present invention at various points in time as two peers are communicating directions and/or GPS coordinates while both are in motion. At time T₁, peer A, containing a GPS device 802, may be driving south on 1^{st} Street and peer B, which includes a GPS enabled telecommunications device 804, is heading north on 3^{rd} Street. Continuing at time T₁, peer B may request directions from peer A for meeting peer A. In providing the directions request, a user of the GPS device in the vehicle of peer A may select a “PEER TO MY CURRENT LOCATION” soft-button 306 of FIG. 3 on the GPS device to enable GPS coordinates to be collected from the telecommunications device of peer B. Peer A may respond to peer B with the following directions, “Continue on 3^{rd} Street, and take a left onto 5^{th} Street.” Peer A and peer B both continue along their paths with peer B taking a left on 5^{th} Street as instructed. At time T₂, peer A is still traveling south on 1^{st} Street and peer B is traveling west on 5^{th} Street and peer B is traveling west on 5^{th} Street. At time T₂, directions from the GPS device of peer A may be updated with the following directions “Continue on 5^{th} Street, take a right onto 1^{st} Street.” At this point, peer A is still to the north of peer B. However, at time T₃, peer A is south of peer B, and updated directions may include the following directions “Continue on 5^{th} Street, take a Left onto 1^{st} Street.” At time T₄, the directions may be “At destination GPS device” because the destination has been reached when peer A and peer B are within a predetermined distance, such as 30 feet. A predetermined distance or threshold may be used by the GPS device to determine when the navigation is complete. In one embodiment, if peer A is within 50 feet of Peer B, the destination may be considered to have been reached and directions guidance may end. Any other set threshold may be used, depending on the particular location, type of vehicle, or desire of user.

In performing the navigation for one or both of the peers, multiple navigation processes may be substantially simultaneously performed. For example, one navigation process can navigate peer A to a fixed location and peer B to peer A's moving location so as to meet and “caravan” to the fixed location. Alternatively, peer A may be navigated to peer B while peer B is being navigated to peer A. It should be understood that more than two navigation processes may be performed simultaneously in the case of a three or more way call being handled by the GPS device.

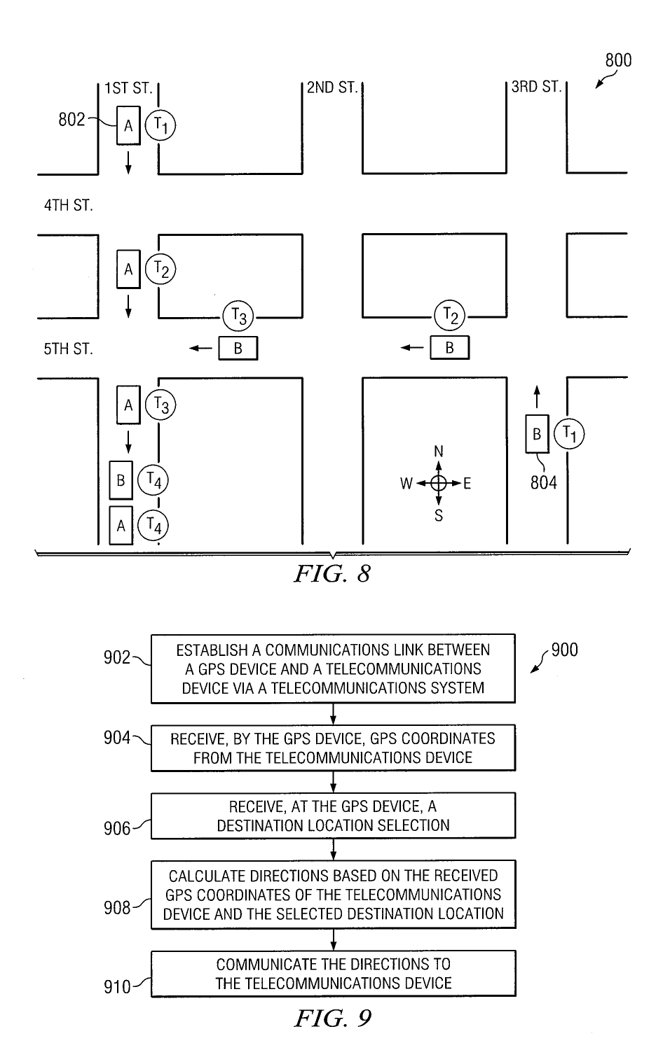

FIG. 9 is a flow chart of an exemplary process 900 for communicating directions and coordinate data between a GPS device and a telecommunications device. In step 902, a communications link may be established between a GPS device and a telecommunications device via a telecommunications system. The communications link may be cellular or any other wireless form of communication in which the GPS device and the telecommunications device is able to communicate. The GPS device may include a transceiver to allow the GPS device to communicate with the telecommunications device or may include another component, such as a Bluetooth™ component, thereby indirectly allowing for communication with the telecommunications device, as described previously.

In step 904, the GPS device may receive GPS coordinates from the telecommunications device. The coordinates received by the GPS device may represent the current location of the telecommunications device, which any GPS-enabled device may be capable of generating. In step 906, a destination location selection may be received at the GPS device. The destination location may be selected using a menu, as described previously in regard to FIG. 3 or may be input using voice commands or any other input method in which the GPS device is capable of using. The destination location may be a static address as well as a mobile location, such as either one of a peer's location.

In step 908, directions may be calculated based on the received GPS coordinates of the telecommunications device and the selected destination location. Using software modules previously described in regard to FIG. 5, directions to the selected destination may be calculated by the GPS device. In step 910, the directions may then be communicated to the telecommunications device. The directions may be in audio format, such as synthesized voice, or text-based format, such as an email or SMS messaging.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed as new and desired to be protected by Letters Patent of the United States is:

1. A method for communicating navigation data from a Global Positioning System (GPS) device to a telecommunications device, said method comprising:
establishing a communications link between a GPS device and a telecommunications device via a telecommunications system;
receiving, by the GPS device, GPS coordinates from the telecommunications device;
receiving, at the GPS device, a destination location selection;
calculating directions based on the received GPS coordinates of the telecommunications device and the selected destination location; and
communicating, by the GPS device, the directions to the telecommunications device.

2. The method according to claim 1, wherein receiving the selected destination location includes receiving the selected destination location in response to a touch screen located on the GPS device being utilized by a user.

3. The method according to claim 1, wherein receiving the selected destination location includes receiving a current location of the GPS device as the selected destination location.

4. The method according to claim 1, further comprising operating multiple navigation processes simultaneously to compute directions for a user of the telecommunications device and user of the GPS device.

5. The method according to claim 1, further comprising displaying both peers on the GPS device.

6. The method according to claim 1, further comprising displaying a selectable option to calculate the directions from a current location of the GPS device to a current location of the telecommunications device.

7. The method according to claim 1, further comprising:
displaying a selectable option to calculate the directions from a current location of the telecommunications device to a current location of the GPS device.

8. The method according to claim 1, further comprising:
generating of at least one an SMS message with the directions; and
communicating the SMS message from the GPS device to the telecommunications device.

9. The message according to claim 1, further comprising:
generating of an audio message with the directions; and
communicating the audio message from the GPS device to the telecommunications device.

10. The message according to claim 1, further comprising:
receiving updated GPS coordinates of the telecommunications device;
re-calculating the directions; and
communicating the re-calculated directions to the telecommunications device.

11. A GPS device, comprising:
an input/output (I/O) unit;
a memory; and
a processing unit in communication with said I/O unit and said processing unit configured to:
establish a communications link with a telecommunications device via a telecommunications system;
receive GPS coordinates from the telecommunications device;
receive a destination location selection;
calculate directions based on the received GPS coordinates of the telecommunications device and the selected destination location; and
communicate the directions to the telecommunications device.

12. The GPS device according to claim 11, wherein said processing unit, in receiving the selected destination location, receives the selected destination location in response to a touch screen located on the GPS device being utilized by a user.

13. The GPS device according to claim 11, wherein said processing unit, in receiving the selected destination location, receives a current location of the GPS device as the selected destination location.

14. The GPS device according to claim 11, wherein said processing unit is further configured to operate multiple navigation processes simultaneously to compute directions for a user of the telecommunications device and user of the GPS device.

15. The GPS device according to claim 11, wherein said processing unit is further configured to display both peers on the GPS device.

16. The GPS device according to claim 15, wherein said processing unit is further configured to display a selectable option to calculate the directions from a current location of the GPS device to a current location of the telecommunications device.

17. The GPS device according to claim 15, wherein said processing unit, is further configured to display a selectable option to calculate the directions from a current location of the telecommunications device to a current location of the GPS device.

18. The GPS device according to claim 11, wherein said processing unit is further configured to:
generate at least one an SMS message with the directions; and
communicate the SMS message from the GPS device to the telecommunications device.

19. The GPS device according to claim 11, wherein said processing unit, is further configured to:
generate an audio message with the directions; and
communicate the audio message from the GPS device to the telecommunications device.

20. The GPS device according to claim 11, wherein said processing unit is further configured to:
receive updated GPS coordinates of the telecommunications device;
re-calculate the directions; and
communicate the re-calculated direction to the telecommunications device.
